(19) United States
(12) Patent Application Publication
(10) Pub. No.: US 2025/0093554 A1
(43) Pub. Date: Mar. 20, 2025

(54) BURNISH-RESISTANT GLASS LAMINATE WITH BURIED INTERFERENCE LAYER

(71) Applicant: Apple Inc., Cupertino, CA (US)

(72) Inventors: Lijie Bao, San Jose, CA (US); Tyler R. Roschuk, San Jose, CA (US); Matthew S. Rogers, San Jose, CA (US)

(73) Assignee: Apple Inc., Cupertino, CA (US)

(21) Appl. No.: 18/885,380

(22) Filed: Sep. 13, 2024

Related U.S. Application Data
(60) Provisional application No. 63/539,534, filed on Sep. 20, 2023.

(51) Int. Cl. G02B 1/14; G02B 5/28

(52) U.S. Cl. CPC G02B 1/14; G02B 5/285

(57) ABSTRACT

An electronic device can include a housing, a display positioned within the housing; and a cover glass disposed over the display and attached to the housing. The cover glass can include a glass sheet; an intermediate hard-coat layer disposed on the glass sheet, having a hardness greater than a hardness of the glass sheet; an interference layer deposited on the intermediate hard-coat layer and having at least two layers with different optical constants and/or thicknesses; and an exterior hard-coat layer deposited on the interference layer. The optical constants and/or thicknesses of the interference layer can be selected based on an optical constant and/or thickness of the exterior hard-coat layer do minimize reflection of the cover glass.

### CROSS-REFERENCES TO RELATED APPLICATIONS

This application claims priority under 35 U.S.C. § 119 (e) to U.S. Provisional Application Ser. No. 63/539,534, filed Sep. 20, 2023, entitled “BURNISH-RESISTANT GLASS LAMINATE WITH BURIED INTERFERENCE LAYER,” which is incorporated herein by reference in its entirety

### FIELD

The described embodiments relate generally to electronic devices that employ a transparent cover glass disposed over a display screen. The transparent cover glass forms an exterior portion of an enclosure of the electronic device and protects the display screen from damage. More particularly, the present embodiments relate to a cover glass formed from various glass or ceramic materials. The cover glass can have one or more layers that comprise silicon dioxide, silicon nitride, or silicon oxynitride, among other materials.

### BACKGROUND

Many portable electronic devices, such as smart phones and tablet computers, include a touch sensitive display. The display assembly is typically a stack of components that includes a display screen, a touch sensitive layer overlaying the display screen and an outer transparent glass sheet, often referred to as a “cover glass” that protects the display and touch sensitive layer. As the cover glass forms a portion of the outer enclosure of the electronic device, the cover glass needs to be strong and resistant to burnishing/scratching while providing low reflection for ease of viewing. The cover glass used for many portable electronic devices includes a relatively thin outer layer that has a low hardness to reduce reflection and is deposited on a harder, underlayer to mitigate deep scratches. However, the low hardness of the outermost layer can result in the cover glass becoming burnished when, for example, the cover glass is stored against a keyboard in a laptop or other folding portable electronic device where the keys may repeatedly rub against the cover glass.

New cover glass materials and/or methods of making cover glasses are needed that are resistant to burnishing and scratching, while also providing low reflectance.

### SUMMARY

In some embodiments an electronic device comprises a housing, a display positioned within the housing and a cover glass disposed over the display and attached to the housing. The cover glass comprises a glass sheet and an interference layer disposed on the glass sheet. The interference layer has a first layer with a first optical constant and a second layer with a second optical constant, wherein the first optical constant is different than the second optical constant. A hard-coat layer is disposed on the interference layer and has a hardness that is greater than the glass sheet. In some embodiments the interference layer includes three or more layers. In various embodiments the first and the second optical constants are selected based at least in part on an optical constant of the hard-coat layer.

In some embodiments the hard-coat layer is predominantly SiON. In various embodiments the interference layer comprises a third layer disposed on the second layer, and the first layer is SiON, the second layer is SiO² and the third layer is SiON. In some embodiments the interference layer comprises a third layer disposed on the second layer, and wherein the first layer is SiN, the second layer is SiO² and the third layer is SiN. In various embodiments the electronic device further comprises a gradient layer disposed on the glass sheet and an intermediate hard-coat layer disposed on the gradient layer, wherein the interference layer is disposed on the intermediate hard-coat layer. In some embodiments each of the first and the second layers have a thickness between 10 and 100 nanometers. In some embodiments the interference layer interacts via destructive interference with the hard-coat layer to reduce a reflectance of the cover glass as compared to a reflectance of the cover glass without the interference layer.

In some embodiments a cover glass comprises a glass sheet, an interference layer disposed on the glass sheet, the interference layer having a first layer with a first optical constant and a second layer with a second optical constant, wherein the first optical constant is different than the second optical constant and a hard-coat layer disposed on the interference layer and having a hardness that is greater than the glass sheet. In various embodiments the interference layer includes three or more layers. In some embodiments the first and second optical constants are selected based at least in part on an optical constant of the hard-coat layer. In various embodiments the hard-coat layer is predominantly SiON. In some embodiments the interference layer comprises a third layer disposed on the second layer, and wherein the first layer is SiON, the second layer is SiO² and the third layer is SiON. In various embodiments the interference layer comprises a third layer disposed on the second layer, and wherein the first layer is SiN, the second layer is SiO² and the third layer is SiN.

In some embodiments the cover glass further comprises a gradient layer disposed on the glass sheet and an intermediate hard-coat layer disposed on the gradient layer, wherein the interference layer is disposed on the intermediate hard-coat layer. In various embodiments each of the first and the second layers have a thickness between 10 and 100 nanometers. In some of the embodiments the interference layer interacts with the hard-coat layer to reduce a reflectance of the cover glass as compared to a cover glass without the interference layer.

In some embodiments a method of forming a transparent substrate comprises providing a glass sheet, depositing a gradient layer on the glass sheet, depositing an intermediate hard-coat layer on the gradient layer, wherein the gradient layer transitions from a composition of the glass sheet to a composition of the intermediate hard-coat layer, depositing an interference layer on the intermediate hard-coat layer, the interference layer having a first layer with a first optical constant and a second layer with a second optical constant, wherein the first optical constant is different than the second optical constant and depositing a hard-coat layer on the interference layer, wherein a hardness of the hard-coat layer is greater than a hardness of the glass sheet. In various embodiments the interference layer comprises three or more layers.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 illustrates a simplified perspective view of an electronic device that can include a cover glass having a buried interference layer according to embodiments of the disclosure;

FIG. 2 illustrate a simplified perspective view of the cover glass illustrated in FIG. 1;

FIG. 3 illustrate a simplified cross-sectional view of the cover glass illustrated in FIGS. 1 and 2, according to some embodiments of the disclosure;

FIG. 4 illustrates steps associated with a method forming a cover glass including n buried interference layer, according embodiments of the disclosure;

FIG. 5 illustrates a simplified cross-sectional view of a cover glass including a buried interference layer, according to some embodiments of the disclosure; and

FIG. 6 illustrates a simplified cross-sectional view of a cover glass including a buried interference layer, according to some embodiments of the disclosure.

### DETAILED DESCRIPTION

Electronic devices often use a cover glass to protect a touch-sensitive display from damage. The cover glass may have a relatively soft top layer that forms an anti-reflective coating to improve the appearance and usability of the electronic device in lighted areas. As the cover glass forms an exterior portion of the enclosure of the electronic device it is subject to mechanical damage, scratching and/or burnishing. In particular, when the outermost layer of the cover glass includes a relatively thin layer of silicon dioxide, the relatively soft silicon dioxide layer may easily become burnished, where the outermost atomic layers are worn down via repeated rubbing on an adjacent surface. The present technology can overcome these issues by forming an exterior hard-coat layer to improve the scratch and burnish resistance of the cover glass, and forming a buried interference layer below the hard coat layer to reduce the reflectance of the cover glass.

In one example a cover glass includes a burnish-resistant exterior hard coating made from silicon oxynitride. An interference layer is formed below the exterior coating and can include a layer of silicon oxynitride, a layer of silicon dioxide and another layer of silicon oxynitride to interact with the exterior layer to improve the reflectance of the cover glass. The optical constants and/or thicknesses of the interference layers can be determined based on the optical constant and/or thickness of the exterior coating to reduce the reflectance of the cover glass (e.g., via engineered destructive and/or constructive interference).

In some embodiments a gradient layer can be first deposited on the glass substrate and a relatively thick intermediate hard-coat layer can be deposited on the gradient layer. The gradient layer can gradually transition from a composition of the glass at the glass substrate to a composition of the intermediate hard-coat layer (e.g., silicon oxynitride) at the intermediate hard-coat layer. The interference layer can then be deposited on the intermediate hard-coat layer and the exterior hard-coat layer can be finally deposited. The gradient layer can improve the reliability of the interface between the intermediate hard-coat layer and the glass layer while the intermediate hard-coat layer can be relatively thick and protect against deep scratches in the cover glass. The buried interference layer can improve the reflectance of the cover glass, for example, as compared to a cover glass without the interference layer.

In order to better appreciate the features and aspects of cover glasses with a buried interference layer for electronic devices according to the present disclosure, further context for the disclosure is provided in the following section by discussing one particular implementation of an electronic device and cover glass structure according to embodiments of the present disclosure. These embodiments are for example only and other embodiments can be employed in other electronic devices such as, but not limited to computers, watches, media players and other devices.

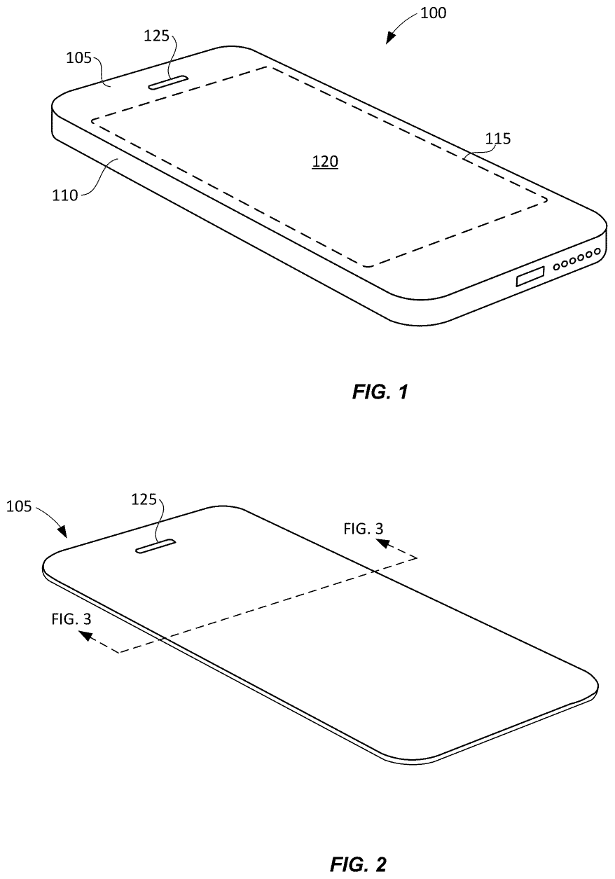

FIG. 1 depicts a simplified perspective view of an electronic device 100 that can include a cover glass having a buried interference layer according to embodiments of the disclosure. As shown in FIG. 1, electronic device 100, which in this example is a smart phone, includes a cover glass 105 attached to a housing 110 and positioned at least partially over a touch-sensitive display 115 that is positioned within housing 110. Cover glass 105 and housing 110 combine to provide an enclosure that houses the various electronic components of electronic device 100 including a processor, communication circuitry, display 115, camera and battery, among other components (not all shown in FIG. 1). Cover glass 105 is transparent and includes a central area 120 that corresponds to display 115, and outside the central display area includes a cut out 125 for a receiver. In some embodiments cover glass 105 provides protection for display 115 and can also form a continuous transparent surface of the enclosure for electronic device 100. Although cover glass 105 is shown in FIG. 1 as covering an entire front portion of electronic device 100, it is understood that cover glass 105 may have any other suitable configuration and for example may only cover central area 120.

FIG. 2 is a simplified perspective view of the cover glass illustrated in FIG. 1. As shown in FIG. 2, cover glass 105 is removed from housing 110 (see FIG. 1). While not visible in FIG. 2, in some embodiments cover glass 105 can include a relatively hard burnish-resistant exterior layer and a buried interference layer, as discussed in more detail below.

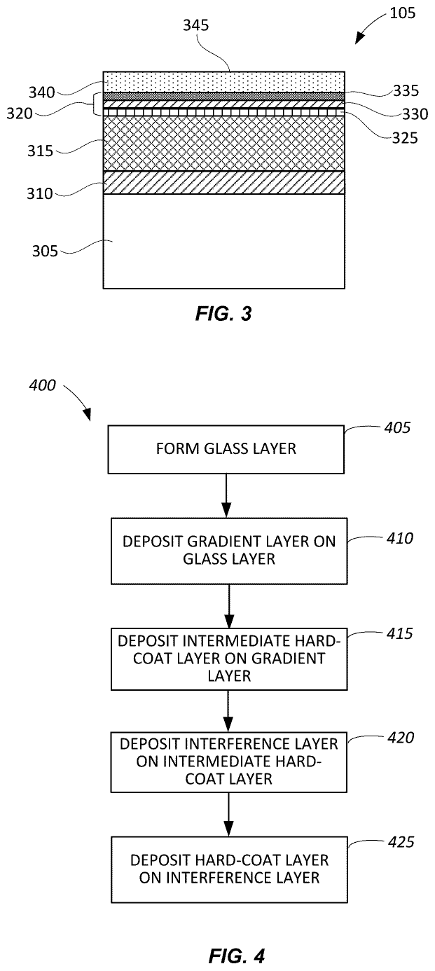

FIG. 3 is a simplified partial cross-sectional view of the cover glass illustrated in FIGS. 1 and 2, according to embodiments of the disclosure. As shown in FIG. 3, cover glass 105 includes a glass layer 305 that may comprise silicon dioxide (SiO₂), including chemically strengthened glass, or other suitable material. A first gradient layer 310 can be formed on glass layer 305. An intermediate hard-coat layer 315 can be formed on first gradient layer 310 and can comprise silicon oxynitride (SiON) or other suitable material. In various embodiments, the first gradient layer 310 transitions from the first composition that is predominantly SiON at the intermediate hard-coat layer 315 to the second composition that is predominantly SiO2. For example, first gradient layer 310 can gradually transition from a composition that is predominantly SiO₂ at glass layer 305 to a composition that is predominantly SiON at intermediate hard-coat layer 315. The slope and thickness of first gradient layer 310 can be controlled to limit the amount of SiO₂ at the interface between the layers.

An interference layer 320 can be deposited on intermediate hard-coat layer 315. In this particular embodiment, interference layer 320 includes three layers, however in other embodiments it can comprise two, four, five or more layers. Interference layer 320 includes a first layer 325 that may comprise a high optical constant (n) silicon oxynitride, a second layer 330 that can comprise silicon dioxide and a third layer 335 that can comprise a high optical constant silicon oxynitride. In some embodiments the high optical constant silicon oxynitride may have an optical constant between 1.8 and 2.1, between 1.9 and 2 or between 1.95 and 1.99. In various embodiments a thickness of each of first, second and third layers, 325, 330, 335, respectively, may be between 5 and 300 nanometers, between 7 and 200 nanometers or between 10 and 100 nanometers. In some embodiments each layer in the interference layer 320 can comprise, silicon dioxide, silicon oxynitride, silicon nitride, niobium oxide, zirconia, tantalum oxide, titanium oxide or other suitable material. In some embodiments the optical constant of each layer can be adjusted by changing the composition of the layer. For example, for silicon oxynitride the oxygen concentration can be increased to decrease the optical constant and decreased to increase the optical constant.

A hard-coat layer 340 can be deposited on interference layer 320 and can comprise silicon oxynitride. In some embodiments hard coat layer 340 can have a hardness that is greater than glass layer 305 and can be made from any suitable material including but not limited to silicon nitride, aluminum oxide, aluminum nitride, boron nitride or zirconium dioxide. In various embodiments hard-coat layer 340 can have a thickness between 25 and 500 nanometers, between 50 and 200 nanometers or between 80 and 100 nanometers.

In some embodiments a reflectance of cover glass 105 can be between 2-10%, between 2-6% or between 3-5%. In various embodiments, an oleophobic coating may be added on top surface 345 of hard-coat layer 340.

FIG. 4 illustrates steps associated with a method of forming a cover glass with an outer gradient layer according to embodiments of the disclosure. As shown in FIG. 4, method 400 includes forming a glass layer (step 405) using any appropriate manufacturing technique. In some embodiments the glass layer is formed from SiO₂ and may include a chemically strengthened glass material.

In step 410 a gradient layer is deposited on the glass layer. The gradient layer can be formed on one or both surfaces of the glass layer. In some embodiments the gradient layer can be deposited using a physical vapor deposition (PVD) sputtering process in which a target containing, for example silicon, is positioned within the PVD chamber and the composition of the gradient layer can be varied from SiO₂ at the glass layer to, for example, SiON at the top surface by varying a partial pressure of oxygen and nitrogen, among other parameters, during the deposition process. The transition from SiO₂ to SiON within the first gradient layer is for example only and as appreciated by one of ordinary skill having the benefit of this disclosure the first gradient layer can transition from a first composition that is substantially similar to a composition of the glass layer at the glass layer to a second composition at the hard coat layer that is substantially similar to a composition of the hard coat layer.

In some embodiments the gradual transition in composition is substantially linear throughout the thickness of the gradient layer while in other embodiments the transition in composition is substantially non-linear. Other deposition techniques than PVD can be used to form the first gradient layer and are within the scope of this disclosure. In some embodiments, the gradient layer can be eliminated and the intermediate hard-coat layer can be deposited directly on the glass layer. In some embodiments a thickness of the gradient layer is between 100 and 500 nanometers, between 150 and 300 nanometers or between 175 and 225 nanometers. In various embodiments the gradient layer can be replaced by one or more layers, for example by alternating silicon dioxide, silicon nitride and/or silicon oxynitride layers, an example of which is described in more detail below.

In step 415 an intermediate hard-coat layer is deposited on the gradient layer. In some embodiments the intermediate hard-coat layer can be made from, but is not limited to silicon oxynitride, silicon nitride, aluminum oxide, aluminum nitride, boron nitride or zirconium dioxide. The intermediate hard-coat layer can have a higher hardness than the glass layer to protect the glass layer from scratches and/or mechanical damage. In some embodiments the intermediate hard-coat layer can be deposited using a physical vapor deposition (PVD) or other suitable process. In various embodiments the intermediate hard-coat layer can have a thickness between 500 and 3000 nanometers, between 1000 and 2000 nanometers or between 1400 and 1800 nanometers. In some embodiments the optical constant of the intermediate hard-coat layer can be between 1.5 and 2, between 1.6 and 1.9 or between 1.7 and 1.8.

In step 420 the interference layer is deposited on the intermediate hard-coat layer. In some embodiments the interference layer may include two, three, four, five or more layers each having the same or a different thickness. In various embodiments the interference layer can be deposited using a physical vapor deposition (PVD) sputtering process and can include alternating high index and low index material layers. For example, in one embodiment the first interference layer is silicon dioxide, the second layer is silicon nitride and the third layer is silicon dioxide. In another embodiment the first layer is high optical constant (n) silicon oxynitride, the second layer is silicon dioxide and the third layer is high optical constant (n) silicon oxynitride. Other embodiments may use a different suitable arrangement and composition of layers. In some embodiments the high optical constant silicon oxynitride may have an optical constant between 1.8 and 2.1, between 1.9 and 2 or between 1.95 and 1.99. In various embodiments a thickness of each of first, second and third layers, respectively, may be between 5 and 300 nanometers, between 7 and 200 nanometers or between 10 and 100 nanometers. In some embodiments a thickness of the interference layer is between 1 and 5 microns, between 1.5 and 3 microns or between 1.9 and 2.1 microns.

In another embodiment the first layer is silicon nitride, the second layer is silicon dioxide and the third layer is silicon nitride. In some embodiments each layer in the interference layer can comprise, silicon dioxide, silicon oxynitride, silicon nitride, nickel oxide, zirconia, tantalum oxide, titanium oxide or other suitable material. In some embodiments the optical constant of each layer can be adjusted by changing the composition of the layer. For example, for silicon dioxide the oxygen concentration can be increased to increase the optical constant and decreased to decrease the optical constant.

In some embodiments the interference layer can be designed to have destructive interference with one or more other layers in the cover glass to reduce reflection within the cover glass. In various embodiments, the interference layer can be designed to reduce reflection when used in combination with the hard-coat layer and/or the intermediate hard-coat layer.

As defined herein, the terms silicon oxide and silicon dioxide can be used interchangeably with all forms of oxygen including O, O₂, and O₃ (e.g., silicon dioxide can be interchanged with SiO or with SiO₃).

In step 425 a hard-coat layer is deposited on the interference layer. In some embodiments the hard-coat layer can be made from, but is not limited to silicon oxynitride, silicon nitride, aluminum oxide, aluminum nitride, titanium nitride or zirconium dioxide. The hard-coat layer can have a higher hardness than the glass layer to protect the glass layer from scratches and/or mechanical damage. In some embodiments the hard-coat layer can be deposited using a physical vapor deposition (PVD) or other suitable process. In various embodiments the hard-coat layer can have a thickness between 25 and 500 nanometers, between 50 and 200 nanometers or between 80 and 100 nanometers. In some embodiments an optional outer layer can be deposited on a top surface of the hard-coat layer and may comprise an oleophobic material to resist fingerprints, etc.

It will be appreciated that method 400 is illustrative and that variations and modifications are possible. Steps described as sequential may be executed in parallel, order of steps may be varied, and steps may be modified, combined, added, or omitted.

Although electronic device 100 (see FIG. 1) is described and illustrated as one particular electronic device, embodiments of the disclosure are suitable for use with a multiplicity of electronic devices. For example, any device that receives or transmits audio, video or data signals can be used with embodiments of the disclosure. In some instances, embodiments of the disclosure are particularly well suited for use with portable electronic media devices because of their use of transparent display screens. As used herein, an electronic media device includes any device with at least one electronic component that can be used to present human-perceivable media. Such devices can include, for example, portable music players (e.g., MP3 devices and Apple's iPod devices), portable video players (e.g., portable DVD players), cellular telephones (e.g., smart telephones such as Apple's iPhone devices), video cameras, digital still cameras, projection systems (e.g., holographic projection systems), gaming systems, PDAs, as well as tablet (e.g., Apple's iPad devices), laptop or other mobile computers. Some of these devices can be configured to provide audio, video or other data or sensory output.

For simplicity, various internal components, such as the control circuitry, graphics circuitry, bus, memory, storage device and other components of electronic device 100 (see FIG. 1) are not shown in the figures.

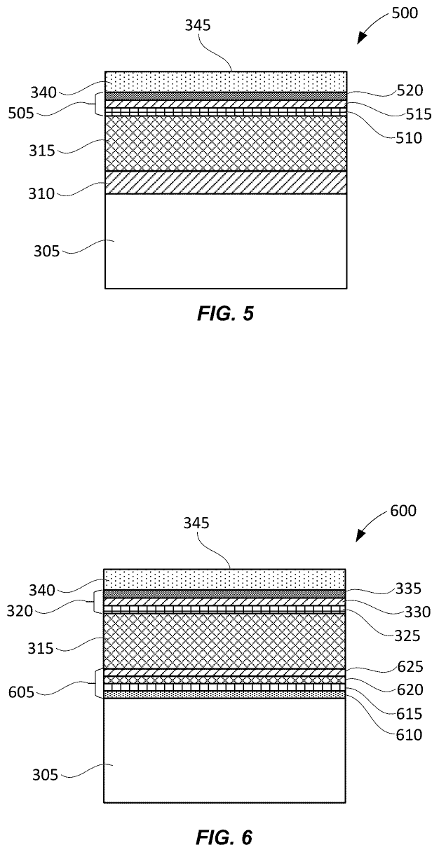

FIG. 5 is a simplified partial cross-sectional view of another embodiment of the cover glass illustrated in FIGS. 1 and 2, according to embodiments of the disclosure. Cover glass 500 may include any of the components, features, or characteristics of any of the cover glass structures previously described with like numbers referring to like items, and the cover glass may be included in any of the electronic devices as previously discussed. As shown in FIG. 5, cover glass 500 includes a glass layer 305 that may comprise silicon dioxide (SiO₂), including chemically strengthened glass, or other suitable material.

A first gradient layer 310 can be formed on glass layer 305. An intermediate hard-coat layer 315 can be formed on first gradient layer 310 and can comprise silicon oxynitride (SiON) or other suitable material. In various embodiments, the first gradient layer 310 transitions from the first composition that is predominantly SiON at the intermediate hard-coat layer 315 to the second composition that is predominantly SiO2. For example, first gradient layer 310 can gradually transition from a composition that is predominantly SiO₂ at glass layer 305 to a composition that is predominantly SiON at intermediate hard-coat layer 315. The slope and thickness of first gradient layer 310 can be controlled to limit the amount of SiO₂ at the interface between the layers.

An interference layer 505 can be deposited on intermediate hard-coat layer 315. In this particular embodiment, interference layer 505 includes three layers, however in other embodiments it can comprise two, four, five or more layers. Interference layer 505 includes a first layer 510 that may comprise silicon nitride, a second layer 515 that can comprise silicon dioxide and a third layer 520 that can comprise a silicon nitride. In various embodiments a thickness of each of first, second and third layers, 325, 330, 335, respectively, may be between 5 and 300 nanometers, between 7 and 200 nanometers or between 15 and 70 nanometers. In some embodiments each layer in the interference layer can comprise, silicon dioxide, silicon oxynitride, silicon nitride, nickel oxide, zirconia, tantalum oxide, titanium oxide or other suitable material. In some embodiments the optical constant of each layer can be adjusted by changing the composition of the layer. For example, for silicon dioxide the oxygen concentration can be increased to increase the optical constant and decreased to decrease the optical constant.

A hard-coat layer 340 can be deposited on interference layer 505 and can comprise silicon oxynitride. In some embodiments hard coat layer 340 can have a hardness that is greater than glass layer 305 and can be made from any suitable material including but not limited to silicon nitride, aluminum oxide, aluminum nitride, titanium nitride or zirconium dioxide. In various embodiments hard-coat layer 340 can have a thickness between 25 and 500 nanometers, between 50 and 200 nanometers or between 80 and 100 nanometers.

In some embodiments a reflectance of cover glass 105 can be between 2-10%, between 2-6% or between 3-5%. In various embodiments, an oleophobic coating may be added on top surface 345 of hard-coat layer 340.

FIG. 6 is a simplified partial cross-sectional view of another embodiment of the cover glass illustrated in FIGS. 1 and 2, according to embodiments of the disclosure. Cover glass 600 may include any of the components, features, or characteristics of any of the cover glass structures previously described with like numbers referring to like items, and the cover glass may be included in any of the electronic devices as previously discussed. As shown in FIG. 6, cover glass 600 is similar to cover glass 105 illustrated in FIG. 3, however cover glass 600 replaces gradient layer 310 with one or more intermediate layers 605 that are disposed on glass layer 305 and that may operate in conjunction with interference layer 320 to optimize optical properties of the cover glass. In one example, the one or more intermediate layers 605 may improve transmittance at 940 nanometers as compared to cover glass 105.

As shown in FIG. 6, cover glass 600 includes a glass layer 305 that may comprise silicon dioxide (SiO₂), including chemically strengthened glass, or other suitable material. In some embodiments one or more intermediate layers 605 may be deposited on glass layer 305 and may include a first layer 610 that comprises silicon dioxide. A second layer 615 may then be deposited and may comprise silicon nitride. A third layer 620 may then be deposited and may comprise silicon dioxide. A fourth layer 625 may then be deposited and may comprise silicon nitride. Although this particular embodiment is described as using four layers to form the one or more intermediate layers 605, in further embodiments fewer or additional layers can be used to achieve the desired optical properties. Further, although a combination of silicon dioxide and silicon nitride layers are used, any suitable composition and/or combination and/or order of layers can be used to achieve the desired optical properties. In various embodiments a thickness of each of first, second, third layers and fourth layers, 610, 615, 620, 625, respectively, may be between 5 and 300 nanometers, between 5 and 200 nanometers or between 5 and 30 nanometers.

An intermediate hard-coat layer 315 can be formed on one or more intermediate layers 605 and can comprise silicon oxynitride (SiON) or other suitable material. An interference layer 320 can be deposited on intermediate hard-coat layer 315. In this particular embodiment, interference layer 320 includes three layers, however in other embodiments it can comprise two, four, five or more layers. Interference layer 320 includes a first layer 325 that may comprise a high optical constant (n) silicon oxynitride, a second layer 330 that can comprise silicon dioxide and a third layer 335 that can comprise a high optical constant silicon oxynitride. In some embodiments the high optical constant silicon oxynitride may have an optical constant between 1.8 and 2.1, between 1.9 and 2 or between 1.95 and 1.99. In various embodiments a thickness of each of first, second and third layers, 325, 330, 335, respectively, may be between 5 and 300 nanometers, between 7 and 200 nanometers or between 10 and 100 nanometers. In some embodiments each layer in the interference layer 320 can comprise, silicon dioxide, silicon oxynitride, silicon nitride, nickel oxide, zirconia, tantalum oxide, titanium oxide or other suitable material. In some embodiments the optical constant of each layer can be adjusted by changing the composition of the layer. For example, for silicon dioxide the oxygen concentration can be increased to increase the optical constant and decreased to decrease the optical constant.

A hard-coat layer 340 can be deposited on interference layer 320 and can comprise silicon oxynitride. In some embodiments hard coat layer 340 can have a hardness that is greater than glass layer 305 and can be made from any suitable material including but not limited to silicon nitride, aluminum oxide, aluminum nitride, titanium nitride or zirconium dioxide. In various embodiments hard-coat layer 340 can have a thickness between 25 and 500 nanometers, between 50 and 200 nanometers or between 80 and 100 nanometers.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

What is claimed is:

1. An electronic device comprising:
a housing;
a display positioned within the housing; and
a cover glass disposed over the display and attached to the housing, the cover glass comprising:
a glass sheet;
an interference layer disposed on the glass sheet, the interference layer having a first layer with a first optical constant and a second layer with a second optical constant, wherein the first optical constant is different than the second optical constant; and
a hard-coat layer disposed on the interference layer and having a hardness that is greater than the glass sheet.

2. The electronic device of claim 1, wherein the interference layer includes three or more layers.

3. The electronic device of claim 1, wherein the first and the second optical constants are selected based at least in part on an optical constant of the hard-coat layer.

4. The electronic device of claim 1, wherein the hard-coat layer is predominantly SiON.

5. The electronic device of claim 1, wherein the interference layer comprises a third layer disposed on the second layer, and wherein the first layer is SiON, the second layer is SiO² and the third layer is SiON.

6. The electronic device of claim 1, wherein the interference layer comprises a third layer disposed on the second layer, and wherein the first layer is SiN, the second layer is SiO² and the third layer is SiN.

7. The electronic device of claim 1, further comprising a gradient layer disposed on the glass sheet and an intermediate hard-coat layer disposed on the gradient layer, wherein the interference layer is disposed on the intermediate hard-coat layer.

8. The electronic device of claim 1, wherein each of the first and the second layers have a thickness between 10 and 100 nanometers.

9. The electronic device of claim 1, wherein the interference layer interacts via destructive interference with the hard-coat layer to reduce a reflectance of the cover glass as compared to a reflectance of the cover glass without the interference layer.

10. A cover glass comprising:
a glass sheet;
an interference layer disposed on the glass sheet, the interference layer having a first layer with a first optical constant and a second layer with a second optical constant, wherein the first optical constant is different than the second optical constant; and
a hard-coat layer disposed on the interference layer and having a hardness that is greater than the glass sheet.

11. The cover glass of claim 10, wherein the interference layer includes three or more layers.

12. The cover glass of claim 10, wherein the first and second optical constants are selected based at least in part on an optical constant of the hard-coat layer.

13. The cover glass of claim 10, wherein the hard-coat layer is predominantly SiON.

14. The cover glass of claim 10, wherein the interference layer comprises a third layer disposed on the second layer, and wherein the first layer is SiON, the second layer is SiO² and the third layer is SiON.

15. The cover glass of claim 10, wherein the interference layer comprises a third layer disposed on the second layer, and wherein the first layer is SiN, the second layer is SiO² and the third layer is SiN.

16. The cover glass of claim 10, further comprising a gradient layer disposed on the glass sheet and an intermediate hard-coat layer disposed on the gradient layer, wherein the interference layer is disposed on the intermediate hard-coat layer.

17. The cover glass of claim 10, wherein each of the first and the second layers have a thickness between 10 and 100 nanometers.

18. The cover glass of claim 10, wherein the interference layer interacts with the hard-coat layer to reduce a reflectance of the cover glass as compared to a cover glass without the interference layer.

19. A method of forming a transparent substrate, the method comprising:
providing a glass sheet;
depositing a gradient layer on the glass sheet;
depositing an intermediate hard-coat layer on the gradient layer, wherein the gradient layer transitions from a composition of the glass sheet to a composition of the intermediate hard-coat layer;
depositing an interference layer on the intermediate hard-coat layer, the interference layer having a first layer with a first optical constant and a second layer with a second optical constant, wherein the first optical constant is different than the second optical constant; and
depositing a hard-coat layer on the interference layer, wherein a hardness of the hard-coat layer is greater than a hardness of the glass sheet.

20. The method of claim 19 wherein the interference layer comprises three or more layers.
